SEQUENCE LISTING (14 sequences)

SEQ ID NO: 1 - DNA, 23 bp, Artificial Sequence
  Forward primer for RBP3 locus
tgtatgatcaccttctatgcttc

SEQ ID NO: 2 - DNA, 23 bp, Artificial Sequence
  Reverse primer for RBP3 locus
gctttaggtaatcatcagatagc

SEQ ID NO: 3 - DNA, 20 bp, Artificial Sequence
  Forward primer for BM3501 locus
ccaacgggttaaaagcactg

SEQ ID NO: 4 - DNA, 21 bp, Artificial Sequence
  Reverse primer for BM3501 locus
ttcctgttccttcctcatctg

SEQ ID NO: 5 - DNA, 23 bp, Artificial Sequence
  Forward primer for MCM38 locus
tggtgaatggtgctctaaaggac

SEQ ID NO: 6 - DNA, 22 bp, Artificial Sequence
  Reverse primer for MCM38 locus
cagccagcagcctctaaaggac

SEQ ID NO: 7 - DNA, 22 bp, Artificial Sequence
  Forward primer for MNS64 locus
attaactttgtggcatctgagc

SEQ ID NO: 8 - DNA, 22 bp, Artificial Sequence
  Reverse primer for MNS64 locus
cgtatcaactaacacgatgctg

SEQ ID NO: 9 - DNA, 20 bp, Artificial Sequence
  Forward primer for MB066 locus
atctgcctgaagccagtcac

SEQ ID NO: 10 - DNA, 20 bp, Artificial Sequence
  Reverse primer for MBo66 locus
ggtttcctgcacctgcatga

SEQ ID NO: 11 - DNA, 20 bp, Artificial Sequence
  Forward primer for IOBT395 locus
acaacaggaaagctctgcca

SEQ ID NO: 12 - DNA, 22 bp, Artificial Sequence
  Reverse primer for IOBT395 locus
acatgtagctgttgatacagat

SEQ ID NO: 13 - DNA, 22 bp, Artificial Sequence
  Forwaard primer for MCMAI locus
cattacagcctgtgtgagtgtg

SEQ ID NO: 14 - DNA, 22 bp, Artificial Sequence
  Reverse primer for MCMAI locus
gatagttctatccaaccgtccc

(19) United States
(12) Patent Application Publication
(10) Pub. No.: US 2014/0121984 A1
(43) Pub. Date: May 1, 2014

(54) MOLECULAR FINGERPRINTING TO IDENTIFY INBREEDING AND OUTBREEDING DEPRESSIONS

(71) Applicants: Ibrahim Abdulwahid Muhammad Arif, Riyadh (SA); Haseeb Ahmad Khan, Riyadh (SA); Ali A. Al-Homaidan, Riyadh (SA); Ahmed Hamed Al-Farhan, Riyadh (SA); Mohammed K.D. Al-Sadoon, Riyadh (SA); Mohammed Yeslam S. Shobrak, Taif (SA)

(72) Inventors: Ibrahim Abdulwahid Muhammad Arif, Riyadh (SA); Haseeb Ahmad Khan, Riyadh (SA); Ali A. Al-Homaidan, Riyadh (SA); Ahmed Hamed Al-Farhan, Riyadh (SA); Mohammed K.D. Al-Sadoon, Riyadh (SA); Mohammed Yeslam S. Shobrak, Taif (SA)

(73) Assignee: KING SAUD UNIVERSITY, RIYADH (SA)

(21) Appl. No.: 13/878,423

(22) PCT Filed: Oct. 11, 2010
(86) PCT No.: PCT/US10/52196

§ 371 Date: Apr. 8, 2013

(51) Int. Cl. G06F 19/22

(52) U.S. Cl. CPC G06F 19/22
USPC 702/19

(57) ABSTRACT

Systems and methods for molecular fingerprinting to identify Inbreeding and Outbreeding Depression Factors (IODFs) in an animal are described. In one aspect, the systems and methods receive inputs such as information pertaining to a set of loci, allele quantity and size, genotype, and/or so on. The systems and methods calculate, based on at least a subset of inputs and a set of microsatellite markers, an IODF. The systems and methods evaluate the calculated IODF to determine if the animal is a suitable/good candidate for a breeding program.

### BACKGROUND

Arabian Oryx (Oryx leucoryx) is an endangered animal that is being saved from extinction by the efforts of captive breeding programs, which have generally been considered a symbol of international conservation success. Long-term success of such programs, however, largely depends on the prudent use of molecular information for conservation management. More specifically, there is some concern that associated animal reintroduction programs might culminate in partial or total collapse of the Arabian Oryx. To maintain the genetic diversity of this endangered species, there is emphasis on implementing screening of different herds of Arabian Oryx for genuine selection of candidates for introduction in wild or for success of captive breeding programs.

### SUMMARY

Systems and methods for molecular fingerprinting to identify Inbreeding and Outbreeding Depression Factors (IODFs) in an animal are described. In one aspect, the systems and methods receive inputs such as information pertaining to a set of loci, allele quantity and size, genotype, and/or so on. The systems and methods calculate, based on at least a subset of inputs and a set of microsatellite markers, an IODF. The systems and methods evaluate the calculated IODF to determine if the animal is a suitable/good candidate for a breeding program.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In the Figures, the left-most digit of a component reference number identifies the particular Figure in which the component first appears.

FIG. 1 shows an exemplary user interface of a computer program module operatively configured to calculate Mean D Square (MDS), observed heterozygosity (H_{O}), and inbreeding-outbreeding depression factor (IODF) to facilitate decisions regarding animal inbreeding and outbreeding characteristics, according to one embodiment.

FIG. 2 shows exemplary H_{O}, MDS, and IODF calculation reports (e.g., reports 1 and 2), according to one embodiment.

FIG. 3 shows an exemplary system for molecular fingerprinting to identify inbreeding and outbreeding depressions, according to one embodiment.

FIG. 4 shows an exemplary procedure for molecular fingerprinting to identify inbreeding and outbreeding depressions, according to one embodiment.

### DETAILED DESCRIPTION

### Overview

Long-term success of captive breeding programs depends on the prudent use of molecular information for conservation management. Mean D square (MDS) and observed heterozygosity (H_{O}) are two absolute measures of determining the genetic makeup of a population. MDS is well suited to detect outbreeding depression whereas H_{O} is especially important for detecting inbreeding depression. More particularly, MDS is based on a stepwise mutation model, characterized by an array of various microsatellite loci demonstrating allelic polymorphism (Valdes et al. 1993, Xu et al. 2000). The observation of MDS focuses on events deeper in the individual's ancestry that may simply not be obtained by H_{O}. Generally, MDS and H_{O} are regarded as independent predictors of outbreeding and inbreeding depressions respectively. A high MDS indicates an outbreeding depression and a low H_{O} indicates an inbreeding depression.

In view of the above, both MDS and H_{O} indices are mutually related to the outbreeding-inbreeding continuum, providing valuable information about suitability of individuals for captive breeding programs. However, an optimal degree of relatedness of mating individuals on the inbreeding-outbreeding continuum will maximize fitness of offspring. Breeding programs need accurate indices to measure the relatedness of parental lineages at both ends of the genomic divergence continuum.

In contrast to conventional techniques, the systems and methods described herein use an array of seven microsatellite markers to generate MDS and H_{O} values automatically. In one implementation, a user inputs information including, but not limited to, a living being's number of loci, number of alleles, size of alleles, and genotypes to determine corresponding MDS and H_{O} values. Then systems and methods compute a novel inbreeding-outbreeding depression factor (IODF) to identify corresponding genetic suitability for a breeding program. In one exemplary implementation, IODF values of <0.5 and >1.5 indicate significant inbreeding and outbreeding depressions, respectively. Since these values are arbitrary and depend on the number of samples, a larger sample size would favor better predictions from IODF values. As such, the novel systems and methods described herein provide a simple and authenticated tool for easy computation of indices of outbreeding-inbreeding continuum to assist in captive breeding, for example, of Arabian Oryx.

### An Exemplary Implementation

### Sample Collection

In one exemplary sample collection, blood samples were collected from twenty-four (24) Arabian Oryx; twenty-one (21) of these samples were obtained from Mahazat As-Sayd Protected Area (MSPA) and three (3) of the samples were from National Wildlife Research Center (NWRC), Saudi Arabia. For statistical evaluation, we considered all the twenty-four (24) samples as a single population due to three main reasons; (i) few samples from NWRC, (ii) NWRC being one of the sources of reintroduction in MSPA and (iii) genetic overlapping because of common founders at both the locations.

### DNA Extraction

In one exemplary DNA extraction procedure, DNA was extracted from two hundred (200) μl blood sample using DNeasy Blood and Tissue Kit (Qiagen GmbH, Germany) according to manufacturer's instructions. The extracted DNA was finally dissolved in 200 μl of elution buffer and stored at −20° C.

### Microsatellite Analysis

This exemplary procedure amplified seven (7) microsatellite loci (RBP3, MCM38, MNS64, IOBT395, MCMAI, BM3501 and MB066) in all the samples. The primer sequences of these markers are shown in TABLE 1.

### (THE REMAINDER OF THIS PAGE IS INTENTIONALLY LEFT BLANK)

TABLE 1
Exemplary Primers Sequences for Amplification of
Seven (7) Microsatellite Loci in Arabian Oryx

| | Primer | | Anneal |
|---|---|---|---|
| | Direc- | | Temp. |
| Locus | tion | Primer Sequence | (° C.) |
| RBP3 | Forward | 5-TGTATGATCACCTTCTATGCTTC | 55 |
| | Reverse | 5-GCTTTAGGTAATCATCAGATAGC | |
| BM3501 | Forward | 5-CCAACGGGTTAAAAGCACTG | 58 |
| | Reverse | 5-TTCCTGTTCCTTCCTCATCTG | |
| MCM38 | Forward | 5-TGGTGAATGGTGCTCTCATACCAG | 58 |
| | Reverse | 5-CAGCCAGCAGCCTCTAAAGGAC | |
| MNS64 | Forward | 5-ATTAACTTTGTGGCATCTGAGC | 58 |
| | Reverse | 5-CGTATCAACTAACACGATGCTG | |
| MB066 | Forward | 5-ATCTGCCTGAAGCCAGTCAC | 58 |
| | Reverse | 5-GGTTTCCTGCACCTGCATGA | |
| IOBT395 | Forward | 5-ACAACAGGAAAGCTCTGCCA | 58 |
| | Reverse | 5-ACATGTAGCTGTTGATACAGAT | |
| MCMAI | Forward | 5-CATTACAGCCTGTGTGAGTGTG | 54 |
| | Reverse | 5-GATAGTTCTATCCAACCGTCCC | |

These particular loci of TABLE 1, although earlier utilized for cattle and Tibetan antelope, have not been utilized to measure inbreeding/outbreeding depression in Arabian Oryx. Zhou et al. (2007) used six of these loci to understand the genetic diversity and population structure of a single population of Tibetan antelopes. MacHugh et al. (1997) used one common locus (RBP3) together with other loci to study cross-species gene flow and phylogeographic pattern of different populations of cattle from Asia, Africa and Europe. Although both of these studies determined H_{O}, they did not compute MDS values for evaluating inbreeding/outbreeding depressions. The forward primer for each marker was labeled with FAM (6-Carboxyfluorescein) whereas the reverse primer was unlabelled. The polymerase chain reactions (PCR) were performed in a total volume of 20 μl containing 2 μl 10×PCR Buffer, 2.5 mM MgCl₂, 200 μM each dNTP, 25 nM of each primer, 25 ng template DNA and 0.5 U Taq DNA polymerase. After initial denaturation at 94° C. for 4 min, 25 cycles of 93° C. for 45 s, 55° C. for 45 s and 72° C. for 45 s were repeated followed by the final extension at 72° C. for 4 min. The aliquots of PCR products (0.25 μl) were mixed with 9.25 μl formamide and 0.25 μl ROX-500 standard. The contents were heated at 95° C. for 2 min and then rapidly cooled on ice before being electrophorsed on 3130XL genetic analyzer (Applied Biosystems, USA) for allele identification.

### Computations of MDS and H_{O}

MDS is calculated using the following equation [1]:

$$MDS = {\sum }_{i = 1}^{N} \frac{{( {n}_{i 1} - {n}_{i 2} )}^{2}}{N}$$

where nᵢ₁ and nᵢ₂ are the number of repeats of the two alleles of the i^{th} locus and N is the total number of microsatellite loci. MDS is based on the difference in the length of two alleles representing the length of time since the two alleles shared a common ancestor.

H_{O} is calculated using the following equation [2]:

$${H}_{O} = \frac{{N}_{AH}}{N}$$

where N_{AH} is the number of loci with heterozygous presentation and N is the total number of loci.

### A Novel Formula to Calculate IODF

The systems and methods described herein utilize the following novel formula [3] to calculate IODF of an individual.

$$IODF = \frac{1}{2} ( {H}_{O} + \frac{{I}^{MDS}}{( {Mean}^{MDS} / {Median}^{MDS} ) N} ) ,$$

where H_{O} is observed heterozygosity and N is total number of individual samples (different animals from the same population). IMDS, Mean^{MDS} and Median^{MDS} are the individual, mean and median MDS values.

### Software Design and Development

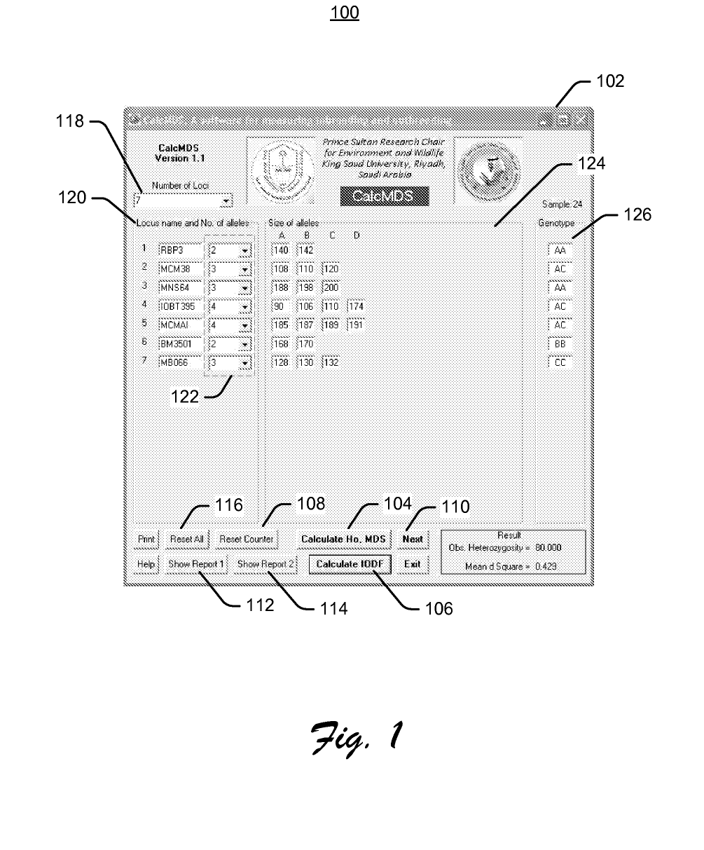

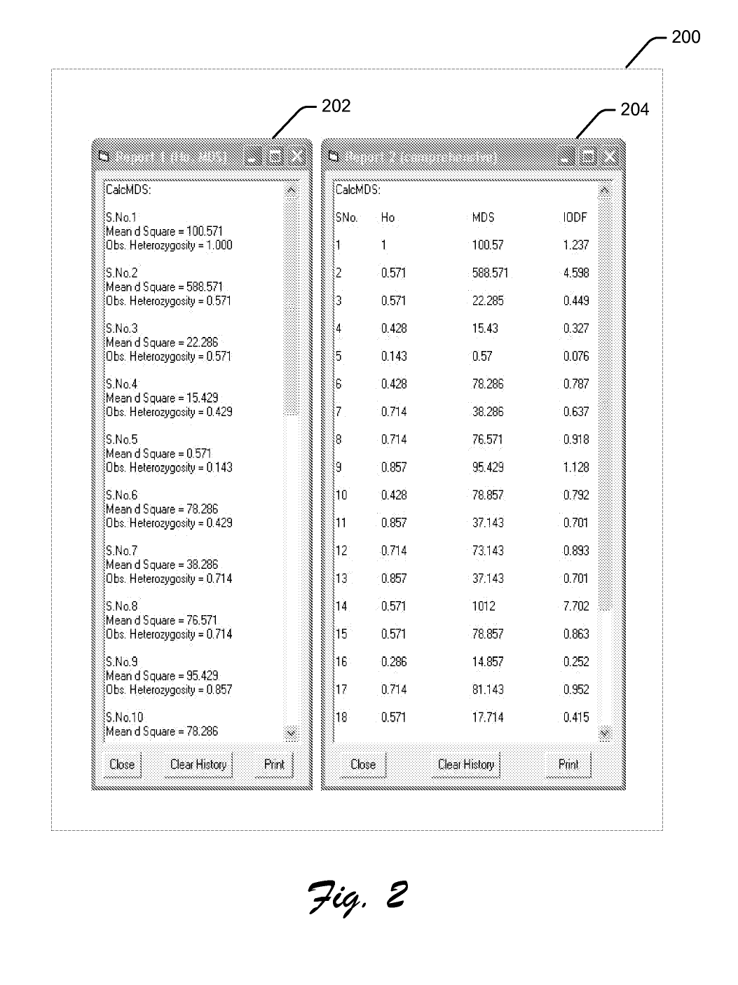

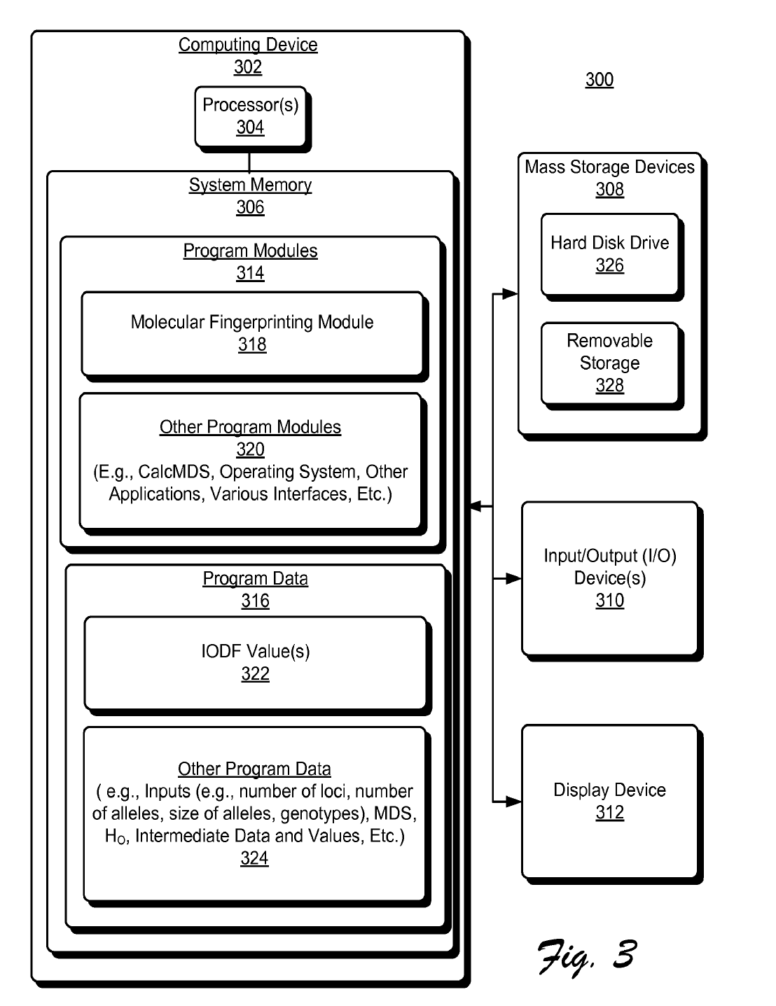

FIG. 1 shows an exemplary user interface (UI) 100 of a computer program module (e.g., “Molecular Fingerprinting Module 318” of FIG. 3, described in detail below) operatively configured to calculate and present Mean D Square (MDS) and observed heterozygosity (H_{O}) to facilitate decisions regarding animal inbreeding and outbreeding characteristics, according to one embodiment. This computer-program software (hereinafter at least partially referred to as “Calc^{MDS}”) was developed and utilized in the exemplary systems and methods. As illustrated, UI 100 includes data input-form 102. Controls on the input-form 102 include, for example:
Calculate H_{O}, MDS (104): When selected, the systems and methods compute MDS and H_{O}. In one implementation, the results of these calculations are shown on the main form 102. In another implementation, results of these calculations are shown in a separate window such as that illustrated in report window 200 of FIG. 2 (e.g., report 202, or “Report 1”).
Calculate IODF (106): When selected, the systems and methods compute IODF value(s)—e.g., value(s) 322 of FIG. 3. Since the computation of IODF uses mean and median values from all the samples of the population understudy, this UI control is selected, for example, after the last samples have been analyzed using “Calculate H_{O}, MDS” button 104. In one implementation, the results are displayed in a report window 200 (FIG. 2) such as report window 204 (“Report 2”).
Reset Counter (108): To reset the sample number to one (1).
Next (110)—to start for the new samples. In this example, all the entries remain the same except an increment in the sample number.
Show Report 1 (112): Present the results of report 1. In one implementation, a report 202 of FIG. 2 is presented to a user displaying H_{O} and MDS.
Show Report 2 (114): Present results of a report 2. In one implementation, a report 204 of FIG. 2 is presented to a user displaying a “comprehensive” report including H_{O}, MDS, and IODF values.
Reset All (116): All the information of loci and alleles is reset and the counter set to 1.

FIG. 2 shows exemplary heterozygosity and MDS calculation reports 200 (e.g., reports 1 (202) and 2 (204)), according to one embodiment. Controls on reports 202 and 204 include, for example:
“Close, which upon selection causes the corresponding report window to be hidden;
“Clear History,” which upon selection causes all the entries in the corresponding report windows to be removed/deleted; and
“Print,” which upon selection prints the corresponding report window.

### Running/Executing Calc^{MDS}

In one implementation, a user selects an icon (e.g., from a desktop or menu) associated with the Calc^{MDS} computer program to instantiate/execute operations of the application. An exemplary representation of such a computer program module is “Molecular Fingerprinting Module 318” of FIG. 3. In this exemplary implementation, the software input window is auto-filled with the information of seven (7) loci to compute MDS and H_{O} of Oryx samples. However, in another implementation, the UI's user-defined format is applied for any combination of additional loci and alleles (e.g., 15 loci with 10 alleles, and/or so on).

Referring to FIG. 1, the user selects the number of loci from the drop-down combo box 118. In one exemplary implementation, and according to this “number of loci” selection, a corresponding number of text boxes (for loci names; optional entry) and combo boxes (for selecting number of alleles) appears on the input form 102 (e.g., see UI block 120).

At this point, the user inputs a respective number of alleles for each locus using drop-down combo boxes (e.g., see UI input controls 122). Note—according to this selection, the respective numbers of text boxes will appear for entering alleles' sizes (124).

To a user inputs respective sizes of all the alleles (allele size input(s) are shown as respective portion(s) of “other program data” 324 of FIG. 3.

The user inputs the respective genotypes for each locus (e.g., please see UI input controls 126). In this exemplary implementation, capital letters are accepted in these text boxes.

The user selects the “Calculate H_{O}, MDS” UI button 104 to compute the MDS and H_{O} (shown as respective portions of “program data” 316 of FIG. 3).

The user selects the “Calculate IODF” UI button 106 to calculate IODF values (i.e., “IODF Value(s)” 322 of FIG. 3). In one exemplary implementation, this particular UI control is enabled only after at least three computations have been made using the “Calculate H_{O}, MDS” button. In other implementations, enablement of this button is based on different number(s) of such computations. In this particular implementation, the microsatellite loci IOBT is computed at the end, i.e., after computing H_{O} and MDS values of all the samples (e.g., via the “Calculate H_{O}, MDS” button 104).

Exemplary Results: Allelic frequencies of microsatellite loci. In this example, and among the 7 microsatellite markers studies:
1. RBP3 (140 and 142 bp) and BM3501 (168 and 170 bp) had two alleles;
2. MCM38 (108, 110 and 120 bp). MNS64 (188, 198 and 200 bp) and MB066 (128, 130 and 132 bp) had three alleles;

IOBT395 (90, 106, 110 and 174) and MCMAI (185, 187, 189 and 191) had four alleles each. Allele frequencies of different microsatellite markers are illustrated, for example, in TABLE 2. An array of 7 microsatellite markers used in this example implementation of the systems and methods clearly differentiated the individual animals.

TABLE 2
Exemplary Allele Frequency for Different
Microsatellite Loci in Arabian Oryx

| | |
|---|---|
| Number of | Alleles |

| Locus | alleles | A | B | C | D |
|---|---|---|---|---|---|
| RBP3 | 2 | 0.583 | 0.417 | — | — |
| MCM38 | 3 | 0.542 | 0.042 | 0.418 | — |
| MNS64 | 3 | 0.479 | 0.458 | 0.063 | — |
| IOBT395 | 4 | 0.417 | 0.042 | 0.437 | 0.104 |
| MCMAI | 4 | 0.271 | 0.500 | 0.146 | 0.083 |
| BM3501 | 2 | 0.313 | 0.687 | — | — |
| MB066 | 3 | 0.146 | 0.333 | 0.521 | — |

Functional Evaluation: The functionality of various control tools of Calc^{MDS} software (e.g., “Molecular Fingerprinting Module 318” of FIG. 3) and accuracy of results were evaluated using the real microsatellite data of 24 specimens from Arabian Oryx. An exemplary set of results outputs of H_{O}, MDS and IODF using the Calc^{MDS} software are shown in TABLE 3. As shown, the specimen Ho ranged from 0.143 to 1.00 with an average of 0.60 whereas the MDS varied from 0.57 to 1023.428 with an average value of 223.357.

### (THE REMAINDER OF THIS PAGE IS INTENTIONALLY LEFT BLANK)

TABLE 3
Observed Heterozygosity (H_{O}), Mean D Square
(MDS) and Inbreeding Outbreeding Depression
Factor (IODF) for 24 Arabian Oryx Samples

| Sample | | | | |
|---|---|---|---|---|
| No. | Hₒ | MDS | IODF | Comments |
| 1 | 1.000 | 100.570 | 1.237042 | |
| 2 | 0.571 | 588.571 | 4.598931 | Outbreeding |
| 3 | 0.571 | 22.285 | 0.448819 | Inbreeding |
| 4 | 0.428 | 15.430 | 0.327081 | Inbreeding |
| 5 | 0.143 | 0.570 | 0.075677 | Inbreeding |
| 6 | 0.428 | 78.286 | 0.787731 | |
| 7 | 0.714 | 38.286 | 0.637585 | |
| 8 | 0.714 | 76.571 | 0.918162 | |
| 9 | 0.857 | 95.430 | 1.127873 | |
| 10 | 0.428 | 78.857 | 0.791915 | |
| 11 | 0.857 | 37.143 | 0.700708 | |
| 12 | 0.714 | 73.143 | 0.89304 | |
| 13 | 0.857 | 37.143 | 0.700708 | |
| 14 | 0.571 | 1012.000 | 7.702095 | Outbreeding |
| 15 | 0.571 | 78.857 | 0.863415 | |
| 16 | 0.286 | 14.857 | 0.251882 | Inbreeding |
| 17 | 0.714 | 81.143 | 0.951669 | |
| 18 | 0.571 | 17.710 | 0.41529 | Inbreeding |
| 19 | 0.714 | 662.857 | 5.214848 | Outbreeding |
| 20 | 0.571 | 1009.714 | 7.685342 | Outbreeding |
| 21 | 0.571 | 1023.428 | 7.785847 | Outbreeding |
| 22 | 0.428 | 58.290 | 0.641187 | |
| 23 | 0.714 | 79.430 | 0.939115 | |
| 24 | 0.428 | 80.000 | 0.800292 | |

The above computations (without “comments”) are also shown in the exemplary Report 2 (204) of FIG. 2.

Implication for Captive Breeding

Both H_{O} and MDS are suitable parameters for detecting inbreeding and outbreeding depressions respectively. Low individual heterozygosity is taken as an indicator of inbreeding whereas a high value of MDS reflects an outbreeding. The exemplary systems and methods illustrated a high level of heterozygosity in this population with an average heterozygosity of 0.601, which is comparable to a decade earlier heterozygosity of MSPA and Thumammah populations of Arabian Oryx. The results of MDS not only exhibited the allelic diversity but also revealed some sort of outbreeding mainly due to the presence of allele D of IOBT395 locus. There has been some evidence for outbreeding depression in Arabian Oryx however, its current intensity may not warrant any management action. Since the heterozygosity and allelic diversity are the reliable predictors of both the survival and adaptation, abilities of populations are important to maintain a high level of heterozygosity and allelic diversity, and thereby, substantially ensure success of captive breeding programs.

The novel Inbreeding and Outbreeding Depression Factor (IODF) of an individual provides a quick view of the individual's suitability for a breeding program based on inbreeding and outbreeding indices. In one exemplary implementation, an acceptable value is in the range of 0.5 and 1.5, whereas IODF<0.5 and >1.5 indicates, for example, inbreeding and outbreeding depressions respectively.

### An Exemplary Computing System

FIG. 3 shows an exemplary computing system for molecular fingerprinting to IODF factors, according to one embodiment. More particularly FIG. 3 shows a suitable computing system 300 where the methods and procedures described herein may be fully or partially implemented. Computing system 300 includes a general-purpose computing device 302. Examples of such general-purpose computing devices include, for example, personal computers, server computers, multiprocessor systems, microprocessor-based systems, network PCs, minicomputers, mainframe computers, distributed computing environments that include any of the above systems or devices, and so on. Compact or subset versions of the described systems and methods may also be implemented in clients of limited resources, such as handheld computers, personal digital assistants, as a plug-in application on a mobile device, or other computing devices.

As illustrated, computing device 302 includes one or more processors 304 operatively coupled to system memory 306, mass storage devices 308, input/output (I/O) device(s) 310, and a display device 312. System memory 306 includes computer storage media in the form of volatile and/or nonvolatile memory such as read only memory (ROM) and random access memory (RAM). A basic input/output system (BIOS) containing the basic routines that help to transfer information between elements within computing device 302, such as during start-up, is typically stored in ROM. RAM typically contains program modules 314 and program data 316.

Computing device 302 may also include other removable/non-removable, volatile/nonvolatile computer storage media. By way of example only, FIG. 3 illustrates a hard disk drive 326 and removable storage 328. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

In this exemplary implementation program modules 312 includes molecular fingerprinting module 318 and “other program modules” 320 such as an operating system, device drivers, and/or so on. Molecular fingerprinting module 318 calculates an Inbreeding Outbreeding Depression Factor (IODF) 322 based on inputs represented by a respective portion of “other program data 324.” More particularly, molecular fingerprinting module 318 receives input data such as a number of loci, number of alleles and respective sizes, genotypes, and/or so on. A user may enter commands and information into the computing device 302 through input/output devices 310. I/O devices are a collection of interfaces that units of an operational system use to communicate with each other. Input devices 110 may include a keyboard, mouse, microphone, joystick, game pad, satellite dish, scanner, or the like. Output devices 110 may include but are not limited to network interface cards, printers, displays, sound systems, and/or so on.

After receiving input data such as that described above, operations of molecular fingerprinting module 318 calculate, using the input data, heterozygosity (H_{O}), Mean D Square (MDS), and Inbreeding Outbreeding Depression Factor (IODF). These various values/results are shown as respective portions of other program data 324. Operations of module 318 evaluate the calculated information to identify suitability for a subject individual for a breeding program. Molecular fingerprinting module 318 then outputs information associated with one or more portions of the calculated information and breeding program evaluation. In one implementation, module to any presents information to a user via display device 112.

Exemplary computing system 300 is only an example of a suitable computing system and is not intended to suggest any limitation as to the scope of use or functionality of systems and methods described herein. For example, although only a single computing device 102 is illustrated, the system could utilize multiple computing devices, for example, in a distributed computing environment to implement the systems and methods described herein. Neither should computing system 300 be interpreted as having any dependency or requirement relating to any one or combination of components illustrated in computing system 300.

### An Exemplary Procedure

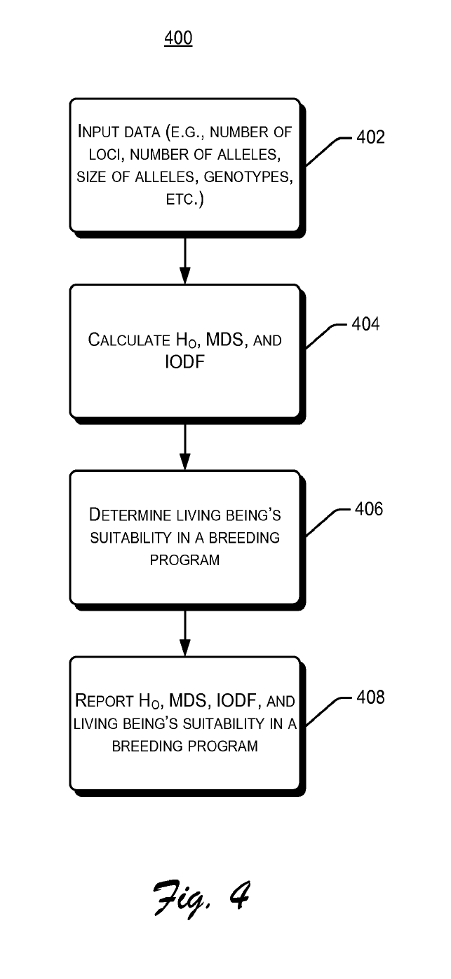

FIG. 4 shows and exemplary procedure 400 for molecular fingerprinting to identify inbreeding and outbreeding depressions, according to one embodiment. At block 402, the procedure 400 receives input data entered, for example, by a user. In one implementation, a user interfaces with the exemplary user interface 100 of FIG. 1 is presented by exemplary computer system 300 of FIG. 3. Input data includes but is not limited to a living being's number of loci, number of alleles, size of alleles, and genotypes. At block 404, the exemplary procedure 400 calculates, using the input data, heterozygosity (H_{O}), Mean D Square (MDS), and Inbreeding Outbreeding Depression Factor (IODF). These various values/results are shown as respective portions of other program data 324 of FIG. 3. At block 406, the exemplary procedure evaluates the calculated information to identify suitability for a subject individual for a breeding program. At block 408, the procedure outputs/displays information associated with one or more portions of the calculated information and breeding program evaluation.

### CONCLUSION

Although the systems and methods for molecular fingerprinting to identify inbreeding and outbreeding depressions have been described in language specific to structural features and/or methodological operations or actions, it is understood that the implementations defined in the appended claims are not necessarily limited to the specific features or actions described. Rather, the specific features and operations of molecular fingerprinting to identify inbreeding and outbreeding depressions are disclosed as exemplary forms of implementing the claimed subject matter.

1. A method at least partially implemented by a computing device, the method comprising:
receiving a set of inputs, the input comprising information associated with a set of loci, allele quantity and size, and genotype;
calculating, based on at least a subset of inputs and a set of microsatellite markers, an Inbreeding Outbreeding Depression Factor (IODF);
evaluating the IODF to determine if an animal associated with the inputs is suitable for a breeding program; and
outputting an indication of suitability of the animal for the breeding program.

2. The method of claim 1 wherein the microsatellite markers comprise a multi-locus individual heterozygosity (H_{O}) and a Mean D Square (MDS), the H_{O} being based on a number of loci that have heterozygous presentation, the MDS being based on a number of repeats of a corresponding set of alleles of a locus.

3. The method of claim 2 wherein the IODF is based on
$$IODF = \frac{1}{2} [ {H}_{O} + \frac{{I}^{MDS}}{( {Mean}^{MDS} / {Median}^{MDS} ) N} ] ;$$
and
wherein N is a total number of individual samples, I^{MDS} is an individual MDS, Mean^{MDS} is a mean MDS, and Median^{MDS} is a median MDS.

4. The method of claim 1 wherein a microsatellite marker of the microsatellite markers is a multi-locus individual heterozygosity (H_{O}), and wherein the method further comprises calculating H_{O} as follows:
$${H}_{O} = \frac{{N}_{AH}}{N} ;$$
and
wherein N_{AH} is a number of loci that have heterozygous presentation and N is a total number of loci.

5. The method of claim 1 wherein a microsatellite marker of the microsatellite markers is a Mean D Square (MDS), and wherein the method further comprises calculating the MDS as follows:
$$MDS = {\sum }_{i = 1}^{N} \frac{{( {n}_{i 1} - {n}_{i 2} )}^{2}}{N} ;$$
and
wherein nᵢ₁ and nᵢ₂ are a number of repeats of the corresponding alleles of the i^{th} locus and N is a total number of microsatellite loci.

6. The method of claim 1 wherein IODF values of lesser than 0.5 and greater than 1.5 indicate significant inbreeding and outbreeding depressions, respectively.

7. The method of claim 1 wherein the IODF is an IODF of an Arabian Oryx for the breeding program.

8. A computing device comprising:
a processor; and
a memory operatively coupled to the processor, the memory comprising computer-program instructions executable by the processor to perform operations comprising:
receiving a set of inputs, the input comprising information associated with a set of loci, allele quantity and size, and genotype;
calculating, based on at least a subset of inputs and a set of microsatellite markers, an Inbreeding Outbreeding Depression Factor (IODF);
evaluating the IODF to determine if an animal associated with the inputs is suitable for a breeding program; and
outputting an indication of suitability of the animal for the breeding program.

9. The computing device of claim 8 wherein the microsatellite markers comprise a multi-locus individual heterozygosity (H_{O}) and a Mean D Square (MDS), the H_{O} being based on a number of loci that have heterozygous presentation, the MDS being based on a number of repeats of a corresponding set of alleles of a locus.

10. The computing device of claim 9 wherein the IODF is based on
$$IODF = \frac{1}{2} [ {H}_{O} + \frac{{I}^{MDS}}{( {Mean}^{MDS} / {Median}^{MDS} ) N} ] ;$$
and
where N is a total number of individual samples, I^{MDS} is an individual MDS, Mean^{MDS} is a mean MDS, and Median^{MDS} is a median MDS.

11. The computing device of claim 8 wherein a microsatellite marker of the microsatellite markers is a multi-locus individual heterozygosity (H_{O}), and wherein the method further comprises calculating H_{O} as follows:
$${H}_{O} = \frac{{N}_{AH}}{N} ;$$
and
wherein N_{AH} is a number of loci that have heterozygous presentation and N is a total number of loci.

12. The computing device of claim 8 wherein a microsatellite marker of the microsatellite markers is a Mean D Square (MDS), and wherein the method further comprises calculating the MDS as follows:
$$MDS = {\sum }_{i = 1}^{N} \frac{{( {n}_{i 1} - {n}_{i 2} )}^{2}}{N} ;$$
and
wherein nᵢ₁ and nᵢ₂ are a number of repeats of the corresponding alleles of the i^{th} locus and N is a total number of microsatellite loci.

13. The computing device of claim 8 wherein IODF values of 0.5 and greater than 1.5 indicate significant inbreeding and outbreeding depressions, respectively.

14. The computing device of claim 8 wherein the IODF is an IODF of an Arabian Oryx for the breeding program.

15. A tangible computer-readable memory comprising computer-program instructions executable by a processor, the computer-program instructions when executed by the processor for performing operations comprising:
receiving a set of inputs, the input comprising information associated with a set of loci, allele quantity and size, and genotype;
calculating, based on at least a subset of inputs and a set of microsatellite markers, an Inbreeding Outbreeding Depression Factor (IODF);
evaluating the IODF to determine if an animal associated with the inputs is suitable for a breeding program; and
outputting an indication of suitability of the animal for the breeding program.

16. The tangible computer-readable memory of claim 15 wherein the microsatellite markers comprise a multi-locus individual heterozygosity (H_{O}) and a Mean D Square (MDS), the H_{O} being based on a number of loci that have heterozygous presentation, the MDS being based on a number of repeats of a corresponding set of alleles of a locus.

17. The tangible computer-readable memory of claim 16 wherein the IODF is based on
$$IODF = \frac{1}{2} [ {H}_{O} + \frac{{I}^{MDS}}{( {Mean}^{MDS} / {Median}^{MDS} ) N} ] ;$$
and
where N is a total number of individual samples, I^{MDS} is an individual MDS, Mean^{MDS} is a mean MDS, and Median^{MDS} is a median MDS.

18. The tangible computer readable memory of claim 15 wherein a microsatellite marker of the microsatellite markers is a multi-locus individual heterozygosity (H_{O}), and wherein the method further comprises calculating H_{O} as follows:
$${H}_{O} = \frac{{N}_{AH}}{N} ;$$
and
wherein N_{AH} is a number of loci that have heterozygous presentation and N is a total number of loci.

19. The tangible computer readable memory of claim 15 wherein a microsatellite marker of the microsatellite markers is a Mean D Square (MDS), and wherein the method further comprises calculating the MDS as follows:
$$MDS = {\sum }_{i = 1}^{N} \frac{{( {n}_{i 1} - {n}_{i 2} )}^{2}}{N} ;$$
and
wherein nᵢ₁ and nᵢ₂ are a number of repeats of the corresponding alleles of the i^{th} locus and N is a total number of microsatellite loci.

20. The tangible computer readable memory of claim 15 wherein the IODF is an IODF of an Arabian Oryx for the breeding program.
